(19) United States
(12) Patent Application Publication
(10) Pub. No.: US 2026/0027676 A1
(43) Pub. Date: Jan. 29, 2026

(54) SYSTEMS AND METHODS FOR DISPLACING VEHICLE PARTS RELATIVE TO EACH OTHER

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 19/276,919

(22) Filed: Jul. 22, 2025

Related U.S. Application Data
(60) Provisional application No. 63/675,672, filed on Jul. 25, 2024.

(51) Int. Cl. B25B 5/00

(52) U.S. Cl. CPC B25B 5/003

(57) ABSTRACT

A part displacement tool for displacing a first part relative to a second part, the part displacement tool comprising a frame, a drive screw, and at least one engaging arm assembly. The frame defines a drive opening and at least one arm opening. The drive screw is supported by the drive opening. The at least one engaging arm assembly is configured to be supported by the at least one arm opening and comprises an engaging member and an engaging screw. Operation of the engaging screw displaces the engaging member relative to the frame.

### RELATED APPLICATIONS

This application (Attorney's Ref. No. P220680) claims benefit of U.S. Provisional Application Ser. No. 63/675,672 filed Jul. 25, 2024, the contents of which are incorporated herein by reference.

### TECHNICAL FIELD

The present invention relates to systems and methods for displacing parts and, more specifically, to systems and methods for displacing a first part relative to a second part.

### BACKGROUND

Vehicle maintenance and repair often requires a first part to be displaced relative to a second part so that one or both of the parts can be repaired and/or replaced. A common part used in vehicles is referred to as a pitman arm. A pitman arm is a shaft typically used as part of a steering system to convert rotary movement into linear movement. More specifically, a pitman arm used as part of a vehicle steering system is configured as a linkage connected between a steering box shaft and a drag link configured to turn the wheels of the vehicle. The pitman arm transmits angular motion from a steering box shaft to linear motion of the drag link to turn the vehicle wheels.

To remove a pitman arm, the pitman arm (first part) is removed from, for example, a drag link (second part) using a pulling tool comprising a generally C-shaped rigid frame and a drive screw threaded through the frame. The frame is engaged with the first part, and the drive screw is rotated relative to the frame to apply a driving force to the second part to displace the pitman arm relative to the drag link until the pitman arm is detached from the drag link.

The need exists for frames for pulling tools that are adapted to securely engage a first part as a drive screw applies a drive force to a second part and which are configured to accommodate first parts of different sizes, shapes, and configurations.

### SUMMARY

The present invention may be embodied as a part displacement tool for displacing a first part relative to a second part. The part displacement tool comprising a frame, a drive screw, and at least one engaging arm assembly. The frame defines a drive opening and at least one arm opening. The drive screw is supported by the drive opening. The at least one engaging arm assembly is configured to be supported by the at least one arm opening and comprises an engaging member and an engaging screw. Operation of the engaging screw displaces the engaging member relative to the frame.

A part displacement tool for displacing a first part relative to a second part, the part displacement tool comprising a frame, a drive screw, and at least one engaging arm assembly. The frame defines a drive opening and at least one arm opening. The drive screw assembly defines a drive axis. The at least one engaging arm assembly defining a grip axis and comprises engaging member, and an engaging screw configured to engage the engaging member. When the at least one engaging arm assembly is arranged in a desired orientation relative to the at least one arm opening, rotation of the engaging screw causes the engaging member to be displaced along the grip axis relative to the frame to engage the second part. When the drive screw assembly is arranged in the drive opening, rotation of the drive screw assembly causes the drive screw to be displaced along the drive axis relative to the frame to engage the first part and displace the first part relative to the second part.

The present invention may also be embodied as a part displacement tool for displacing a first part relative to a second part comprising a frame, a drive screw assembly, and at least one engaging arm assembly. The frame defines a drive opening and at least one arm opening. The drive screw assembly defines a drive axis comprising a drive screw and a drive screw cap configured to engage at least a portion of the drive screw. The at least one engaging arm assembly defines a grip axis and comprises an engaging member and an engaging screw configured to engage the engaging member. When the at least one engaging arm assembly is arranged in a desired orientation relative to the at least one arm opening, rotation of the engaging screw causes the engaging member to be displaced along the grip axis relative to the frame to engage the second part. When the drive screw is arranged in the drive opening, rotation of the drive screw causes the drive screw to be displaced along the drive axis relative to the frame such that the drive screw cap displaces the first part relative to the second part.

The present invention may also be embodied as a method for displacing a first part relative to a second part comprising the following steps. A frame defining a drive opening and at least one arm opening is provided. A drive screw assembly defining a drive axis is provided. At least one engaging arm assembly defining a grip axis is provided. The at least one engaging arm assembly comprises an engaging member and an engaging screw configured to engage the engaging member. The at least one engaging arm assembly is arranged in a desired orientation relative to the at least one arm opening such that rotation of the engaging screw causes the engaging member to be displaced along the grip axis relative to the frame to engage the second part. The drive screw assembly is arranged in the drive opening such that rotation of the drive screw assembly causes the drive screw to be displaced along the drive axis relative to the frame to engage the first part and displace the first part relative to the second part.

### BRIEF DESCRIPTION OF THE DRAWINGS

FIG. 1 is an exploded view of a first example part displacement tool for displacing a first part relative to a second part;

FIG. 2 is a side elevation view of the first example part displacement tool in a first configuration;

FIG. 3 is a bottom plan view of the first example part displacement tool in the first configuration;

FIG. 4 is a side elevation partial section view taken along lines 4-4 in FIG. 3;

FIG. 5 is a side elevation partial section view similar to FIG. 4 but showing the first example part displacement tool in a second configuration;

FIG. 6 is a side elevation partial section view similar to FIG. 5 but showing the first example part displacement tool arranged to begin displacing a first part relative to a second part;

FIG. 7 is a side elevation partial section view similar to FIG. 6 but showing the first example part displacement tool after a first part has been removed or detached from the second part; and

FIG. 8 is a section view depicting a portion of a drive screw assembly used by the first example displacement tool.

### DETAILED DESCRIPTION

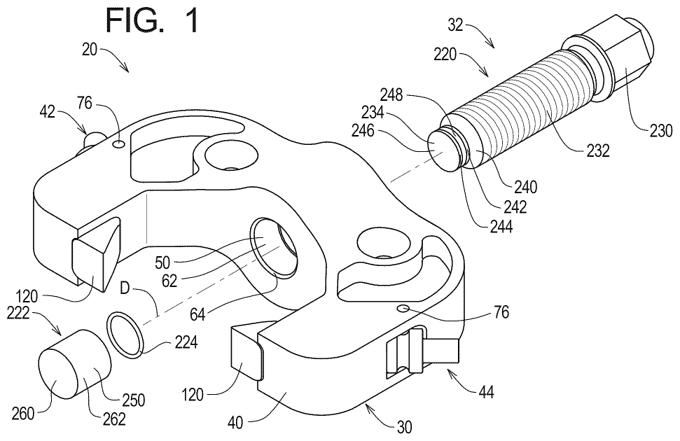

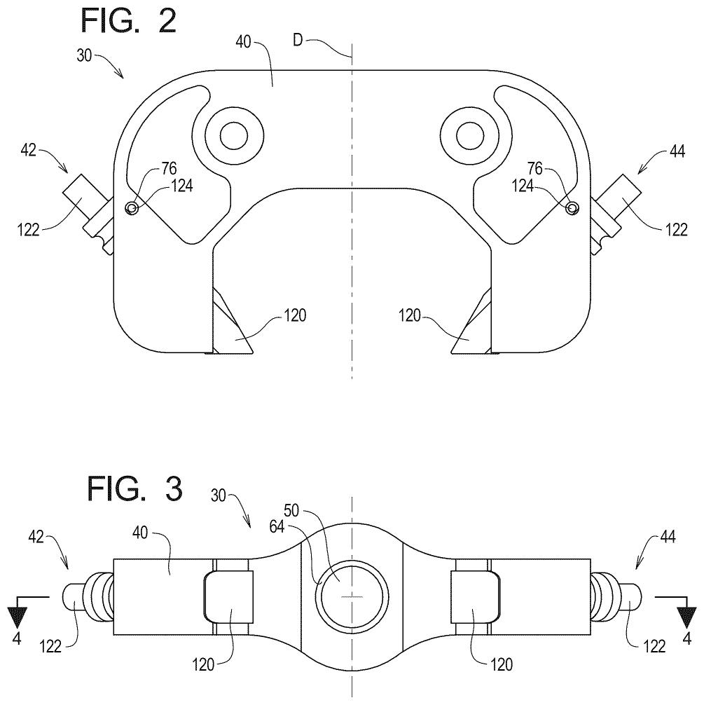

Referring initially to FIGS. 1, 6, and 7 of the drawing, depicted therein is a first example part displacement tool 20 for displacing a first part 22 relative to a second part 24. The first part 22 and second part 24 are not per se part of the present invention and will be discussed herein only to that extent helpful to a complete understanding of the first example part displacement tool 20.

The first example part displacement tool 20 comprises a frame assembly 30 and a drive screw assembly 32. The example frame assembly 30 comprises a frame member 40 and first and second engaging arm assemblies 42 and 44. The frame member 40 is configured to support the screw drive assembly 32 for movement along a drive axis D and to support the first and second engaging arm assemblies 42 and 44 for movement along first and second grip axes G1 and G2, respectively. In addition, the example arm assemblies 42 and 44 are supported by the frame member 40 such that the first and second grip axes G1 and G2 extend at an angle with respect to the drive axis D defined by the first example part displacement tool 20.

The example arm assemblies 42 and 44 are thus both adjustable to allow the first example part displacement tool 20 easily to accommodate different sizes, shapes, and configurations of the first part 22 and the second part 24. Further, the angles at which the first and second grip axes G1 and G2 extend relative to the drive axis D secures the first and second engaging arm assemblies 42 and 44 in a desired orientation relative to the frame member 40 during use of first example part displacement tool 20.

With the foregoing general understanding of the construction and operation of the present invention in mind, details of the construction and use of the first example part displacement tool 20 will now be described in further detail.

The example frame member 40 defines a drive opening 50, a first arm opening 52, and a second arm opening 54. The example drive opening 50 defines a first drive opening portion 60, a second drive opening portion 62, and a first pin groove 64.

The example first and second engaging arm openings 52 and 54 are or may be the same, and the same reference characters will be used to refer to the portions of the first and second engaging arm openings 52 and 54. Each of the example first and second arm openings 52 and 54 defines an arm opening first portion 70, an arm opening second portion 72, an arm drive opening neck portion 74, and an arm opening notch portion 76.

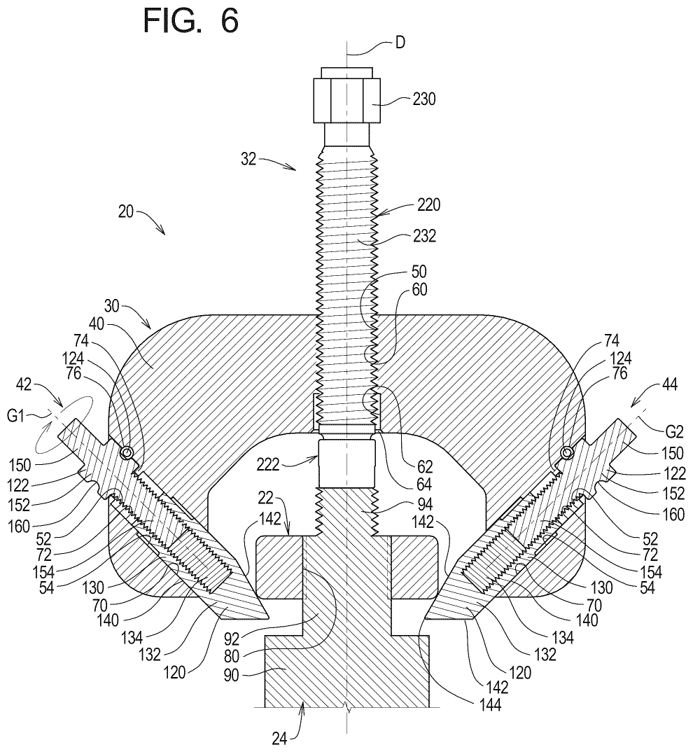

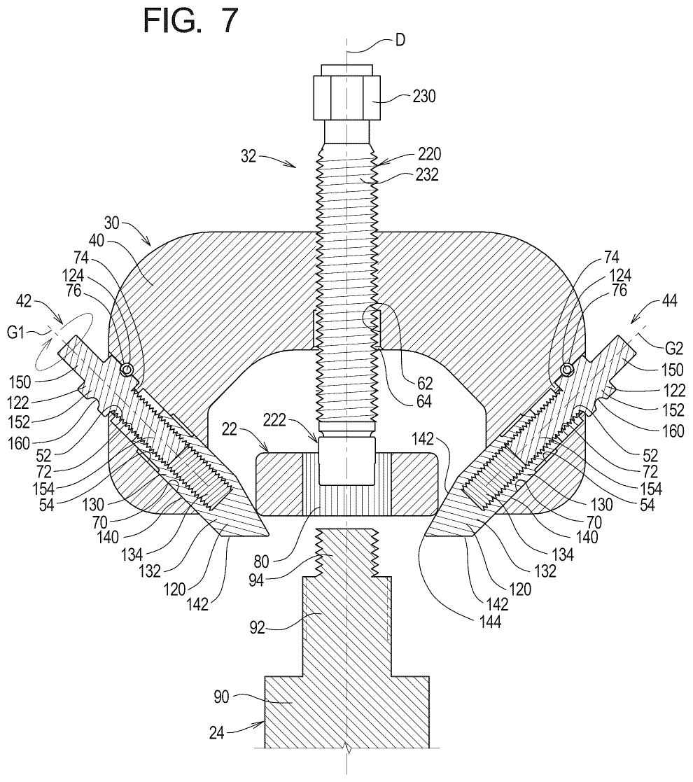

As perhaps best shown in FIGS. 6 and 7, the example first part 22 is or may be a pitman arm of a vehicle steering system (not shown), and the example second part 24 may be a drag shaft of the vehicle steering system (not shown). The pitman arm forming the example first part 22 defines a first part opening 80. The drag shaft forming the example second part 24 comprises a second part base 90, a second part engaging portion 92, and a second part threaded portion 94. A nut (already removed) is typically secured to the second part threaded portion 94 during use of the steering system incorporating the first and second parts 22 and 24.

The example first and second engaging arm assemblies 42 and 44 are the same, and the same reference characters will be used to refer to the components of the first and second engaging arm assemblies 42 and 44. Each of the arm assemblies 42 and 44 comprises an engaging member 120, an engaging screw 122, and an engaging pin 124.

The example engaging member 120 defines a first engaging member portion 130, a second engaging member portion 132, and a bore portion 134. The example first engaging member portion 130 is cylindrical. The example second engaging member portion 132 defines one or more guide surface portions 140, one or more engaging surface portions 142, and an engaging tip 144. The example first engaging member portion 130 is sized and dimensioned to be received within the arm opening first portion 70 such that the engaging member 120 may move within a limited range of movement along the grip axes G1 or G2 relative to the frame member 40 but not axially rotate relative to the frame member 40. The example second engaging member portion 130 is sized and dimensioned to be received within the arm opening first portion 70 such that the engaging member 120 may move within a limited range of movement along the grip axes G1 or G2 relative to the frame member 40 and to axially rotate relative to the frame member 40. The example bore portion 134 is internally threaded.

The example engaging screw 122 defines an arm drive head portion 150, a pin guide portion 152, and a shaft portion 154. The example arm drive head portion 150 is configured to facilitate manual axial rotation of the engaging screw 122. The example pin guide portion 152 is substantially cylindrical and defines a pin groove 160. The example shaft portion 154 is externally threaded.

The example drive screw assembly 32 comprises a drive screw member 220, a drive screw cap 222, and a retaining member 224.

The example drive screw member 220 defines a drive end 230, a shaft 232, and an engaging end 234. The engaging end 234 defines a first engaging end portion 240, a second engaging end portion 244, a third engaging end portion 244, and a drive screw bearing surface 246. A first retaining groove 248 is formed in the third engaging end portion 244.

The example drive screw cap 222 defines a cap outer surface 250 and a cap inner surface 252 defining a cap cavity 254. The example outer surface 250 defines an outer surface bearing portion 260 and an outer surface transition surface 262. The example inner surface 252 defines a second retaining groove 270 and a inner surface bearing portion 272.

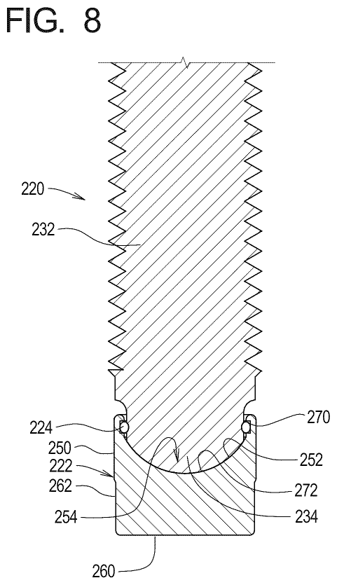

To assemble the first example part displacement tool 20, the drive screw member 220 is threaded into the drive opening 50 of the frame member 40. The drive screw cap 222 is then detachably attached to the drive screw member 220 by arranging the drive screw cap 222 and retaining member 224 such that the retaining member 224 is partly within each of the first and second retaining grooves 248 and 270 as shown in FIG. 8.

The engaging members 120 are then arranged within the arm opening first portions 70. The engaging screws 122 are then arranged such that shaft portion thereof engages the bore portion 134. The engaging screw 122 is then arranged such that the pin guide portion 152 is at least partly within the arm opening second portion 72. The neck portion 74 stops the pin guide portion 152 when the pin groove 160 is aligned with the arm opening pin hole 76. The engaging pin 124 is then inserted through the arm opening pin hole 76 such that at least a portion of the engaging pin 124 is within the pin groove 160.

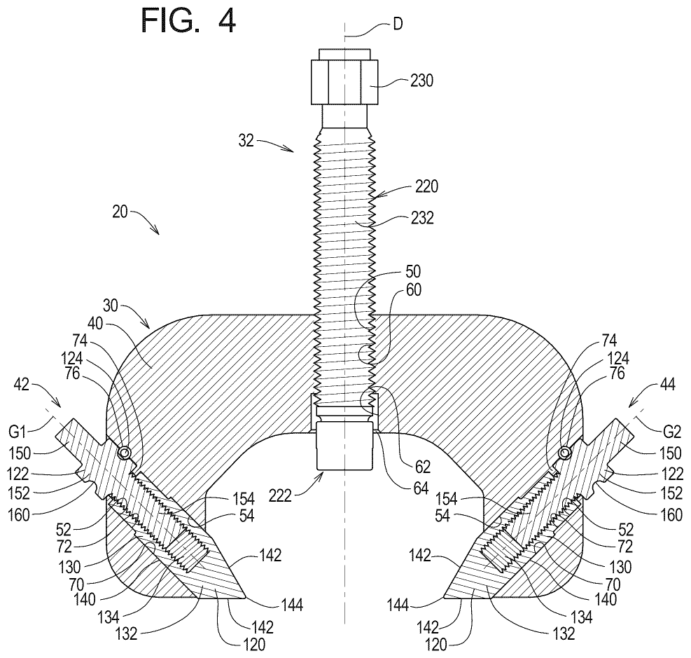

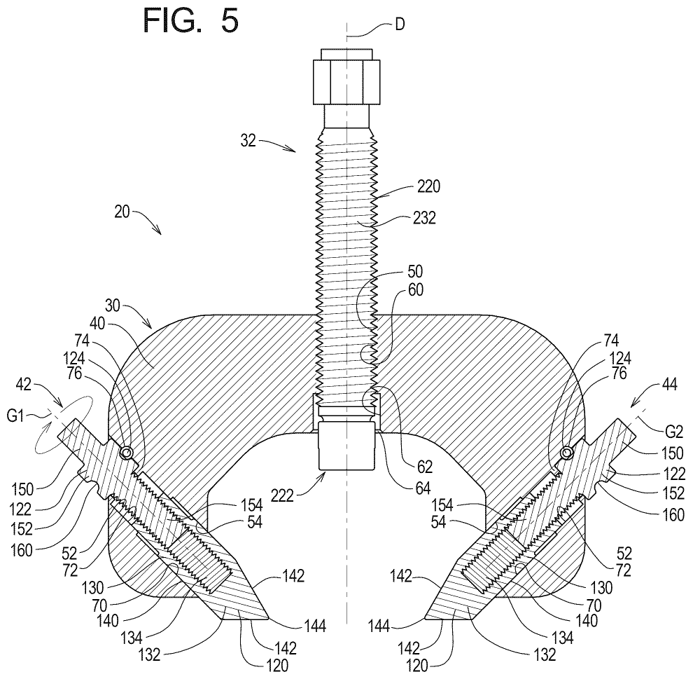

The threaded external surface of the engaging screw shaft portion 154 engages the internally threaded bore portion 134 of the engaging member 120 such that axial rotation of the engaging screw 122 is translated into linear movement of the engaging member 120 as shown by a comparison of FIGS. 4 and 5.

As shown in FIG. 6, to use the first example displacement tool 20 to displace the first part 22 relative to the second part 24, the first example displacement tool 20 is configured and arranged such the first and second engaging arm assemblies 42 and 44 engage the first part 22 and that axial rotation of the drive screw assembly 32 causes the drive screw member 220 to move along the drive axis D such that the drive screw cap 222 comes into contact with the second part 24. Further axial rotation of the drive screw member 220 forces the first part 22 away from the second part 24 as shown by a comparison of FIGS. 6 and 7.

The example frame assembly 30 comprises two of the engaging arm assemblies (e.g., 42 and 44), but only one engaging arm assembly need be used to implement the principles of the present invention. Further, the angles between the grip axes G1 and G2 and the drive axis D are the same in the example frame assembly 30, but these angles may be different. Finally, instead of the example drive screw assembly 32, a drive screw member (without the drive screw cap and retaining member) may be used.

What is claimed is:

1. A part displacement tool for displacing a first part relative to a second part, the part displacement tool comprising:
a frame defining a drive opening and at least one arm opening;
a drive screw assembly defining a drive axis;
at least one engaging arm assembly defining a grip axis comprising
an engaging member, and
an engaging screw configured to engage the engaging member; wherein
when the at least one engaging arm assembly is arranged in a desired orientation relative to the at least one arm opening, rotation of the engaging screw causes the engaging member to be displaced along the grip axis relative to the frame to engage the second part;
when the drive screw assembly is arranged in the drive opening, rotation of the drive screw assembly causes the drive screw to be displaced along the drive axis relative to the frame to engage the first part and displace the first part relative to the second part.

2. The part displacement tool of claim 1, in which the drive screw assembly comprises
a drive screw, and
a drive screw cap configured to engage at least a portion of the drive screw.

3. The part displacement tool of claim 2, further comprising a retaining member configured to engage at least a portion of the drive screw and at least a portion of the drive screw cap.

4. The part displacement tool of claim 2, in which the drive screw cap is arranged on the drive screw such that the drive screw cap engages the first part when the drive screw is displaced along the drive axis.

5. The part displacement tool of claim 1, in which the at least one engaging arm assembly comprises an engaging pin configured to engage at least a portion of the engaging screw and at least a portion of the frame.

6. The part displacement tool of claim 1, comprising
first and second arm openings;
first and second engaging arm assemblies; wherein
the first and second engaging arm assemblies are arranged in first and second desired orientations relative to the first and second arm openings, respectively.

7. The part displacement tool of claim 6, in which the first and second engaging arm assemblies define first and second grip axes, respectively, such that a first engaging member of the first engaging arm assembly is displaced along the first grip axis and a second arm member of the second engaging arm assembly is displaced along the second grip axis.

8. The part displacement tool of claim 1, in which the engaging member defines at least one engaging surface portion and an engaging tip.

9. A part displacement tool for displacing a first part relative to a second part, the part displacement tool comprising:
a frame defining a drive opening and at least one arm opening;
a drive screw assembly defining a drive axis comprising
a drive screw, and
a drive screw cap configured to engage at least a portion of the drive screw;
at least one engaging arm assembly defining a grip axis comprising
an engaging member, and
an engaging screw configured to engage the engaging member; wherein
when the at least one engaging arm assembly is arranged in a desired orientation relative to the at least one arm opening, rotation of the engaging screw causes the engaging member to be displaced along the grip axis relative to the frame to engage the second part;
when the drive screw is arranged in the drive opening, rotation of the drive screw causes the drive screw to be displaced along the drive axis relative to the frame such that the drive screw cap displaces the first part relative to the second part.

10. The part displacement tool of claim 9, in which the drive screw assembly further comprises a retaining member configured to engage at least a portion of the drive screw and at least a portion of the drive screw cap.

11. The part displacement tool of claim 9, in which the at least one engaging arm assembly comprises an engaging pin configured to engage at least a portion of the engaging screw and at least a portion of the frame.

12. The part displacement tool of claim 9, comprising
first and second arm openings;
first and second engaging arm assemblies; wherein
the first and second engaging arm assemblies are arranged in first and second desired orientations relative to the first and second arm openings, respectively.

13. The part displacement tool of claim 12, in which the first and second engaging arm assemblies define first and second grip axes, where a first engaging member is displaced along the first grip axis and a second engaging member is displaced along the second grip axis.

14. A method for displacing a first part relative to a second part, the method comprising the steps of:
providing a frame defining a drive opening and at least one arm opening;
providing a drive screw assembly defining a drive axis;
providing at least one engaging arm assembly defining a grip axis comprising
an engaging member, and
an engaging screw configured to engage the engaging member;
arranging the at least one engaging arm assembly in a desired orientation relative to the at least one arm opening such that rotation of the engaging screw causes the engaging member to be displaced along the grip axis relative to the frame to engage the second part; and
arranging the drive screw assembly in the drive opening such that rotation of the drive screw assembly causes the drive screw to be displaced along the drive axis relative to the frame to engage the first part and displace the first part relative to the second part.

15. The method of claim 14, in which the step of providing a drive screw assembly comprises:
providing a drive screw, and
providing a drive screw cap configured to engage at least a portion of the drive screw.

16. The method of claim 15, further comprising providing a retaining member configured to engage at least a portion of the drive screw and at least a portion of the drive screw cap.

17. The part displacement tool of claim 15, further comprising arranging the drive screw cap on at least a portion of the drive screw such that the drive screw cap engages the first part when the drive screw is displaced along the drive axis.

18. The method of claim 14, in which the step of providing at least one engaging arm assembly further comprises providing an engaging pin configured to engage at least a portion of the engaging screw and at least a portion of the frame.

19. The method of claim 14, further comprising
providing first and second arm openings;
providing first and second engaging arm assemblies; and
arranging the first and second engaging arm assemblies in first and second desired orientations relative to the first and second arm openings.

20. The method of claim 19, in which the step of providing the first and second arm assemblies comprises the step of configuring the first and second arm assemblies to define first and second grip axes such that a first engaging member of the first engaging arm assembly is displaced along the first grip axis and a second engaging member of the second arm assembly is displaced along the second grip axis.
